(19) United States
(12) Patent Application Publication
(10) Pub. No.: US 2025/0362643 A1
(43) Pub. Date: Nov. 27, 2025

(54) EXPOSURE DEVICE AND IMAGE FORMING APPARATUS

(71) Applicant: CANON KABUSHIKI KAISHA, Tokyo (JP)

(72) Inventors: YU OGURO, Ibaraki (JP); YUUTA SAKURAI, Chiba (JP); AKIHISA YAMADA, Ibaraki (JP); HIROKI TAKANO, Saitama (JP); KENJI SUZUKI, Chiba (JP); HIROSHI NAKAHATA, Chiba (JP); TAKEHIRO ISHIDATE, Tokyo (JP)

(21) Appl. No.: 19/213,379

(22) Filed: May 20, 2025

(30) Foreign Application Priority Data
May 27, 2024 (JP) 2024-085794

(51) Int. Cl. G03G 21/20; B41J 2/447; B41J 2/47; B41J 29/377; G02B 19/00; G03G 15/01; G03G 15/04; G03G 15/043

(52) U.S. Cl. CPC G03G 21/206; B41J 2/447; B41J 2/47; B41J 29/377; G02B 19/0009; G02B 19/0047; G03G 15/011; G03G 15/0189; G03G 15/04036; G03G 15/0435

(57) ABSTRACT

An exposure device includes a substrate on which a plurality of light emitting elements is arranged in the axial direction of the photosensitive member; a lens array including a plurality of lenses that condense the light emitted from the light emitting elements onto the photosensitive member; a housing that has an opening, and holds the substrate and the lens array; a housing support member that is provided integrally on the housing to cover the opening of the housing, and forms a space that allows air to circulate between the housing and the exposure device; and a sealing member that seals a gap between the housing and the housing support member facing each other on one side and the other side of the substrate in a direction orthogonal to the optical axis direction along the optical axis of the lenses and the axial direction.

### BACKGROUND

### Field

The present disclosure relates to an exposure device that exposes a photosensitive member, and an image forming apparatus including the exposure device.

### Description of the Related Art

As a conventional exposure device to be used in an electrophotographic image forming apparatus, there is a known exposure device of an LED array system in which a plurality of light emitting elements is arranged in the axial direction of a photosensitive member.

This type of exposure device is known to dissipate heat depending on the duration of a light emission time and the amount of light emission from the light emitting elements. Further, the exposure device is disposed close to a development device that develops, with toner, a latent image to be formed on the photosensitive member. Therefore, to reduce the influence of heat from the exposure device on the toner, a technique for suppressing the temperature rise in the exposure device is known.

### SUMMARY

A typical configuration according to some embodiments of the present disclosure includes a substrate on which a plurality of light emitting elements that emit light to expose a photosensitive member is arranged in the axial direction of the photosensitive member; a lens array including a plurality of lenses that condense the light emitted from the light emitting elements onto the photosensitive member; a housing that has an opening, and holds the substrate and the lens array; a housing support member that is provided integrally on the housing to cover the opening of the housing, and forms a space that allow air to circulate between the housing and the exposure device; and a sealing member that seals a gap between the housing and the housing support member facing each other on one side and the other side of the substrate in a direction orthogonal to the optical axis direction along the optical axis of the lenses and the axial direction.

Further features of the present disclosure will become apparent from the following description of exemplary embodiments with reference to the attached drawings.

### BRIEF DESCRIPTION OF THE DRAWINGS

FIG. 1 is a perspective view of an image forming apparatus.

FIG. 2 is a schematic cross-sectional view of the image forming apparatus.

FIG. 3 is a schematic cross-sectional view of the image forming apparatus.

FIGS. 4A and 4B are perspective views of the configuration in the periphery of drum units and developing units.

FIG. 5 is a schematic cross-sectional view of an exposure head.

FIG. 6 is a perspective view of an exposure head as viewed from above.

FIG. 7 is a perspective view of an exposure head as viewed from below.

FIGS. 8A, 8B, and 8C are views of a substrate in an exposure head, and FIGS. 8D and 8E are views of a lens array.

FIG. 9 is a perspective view of a cartridge tray, an inner door in a closed state, and an exposure head at an exposure position.

FIG. 10 is a perspective view of a cartridge tray, an inner door in an open state, and an exposure head at a retraction position.

FIG. 11 is a cross-sectional view taken along the line A-A defined in FIG. 2;

FIG. 12 is a perspective view of a duct unit.

FIG. 13 is a perspective view of the cartridge tray and a lifting and lowering duct as viewed from below.

FIG. 14 is a cross-sectional view taken along the line X-X defined in FIG. 13.

FIG. 15 is a diagram showing the longitudinal lengths of a sheet and an opening of an exposure head according to a first embodiment.

FIG. 16 is a cross-sectional view of an exposure head according to the first embodiment.

FIG. 17 is a perspective view of an exposure head according to the first embodiment.

FIG. 18 is a perspective view of an exposure head, the lifting and lowering duct, and the duct unit according to the first embodiment.

FIG. 19 is a cross-sectional view of an exposure head according to a second embodiment.

FIG. 20 is a cross-sectional view of an exposure head according to a third embodiment.

### DESCRIPTION OF THE EMBODIMENTS

The following is a description of embodiments for carrying out the present disclosure, with reference to the drawings. Note that the dimensions, materials, shapes, relative positions, and the like of the components described below are merely examples, and the scope of the present disclosure is not limited to those examples.

### First Embodiment

### (Image Forming Apparatus)

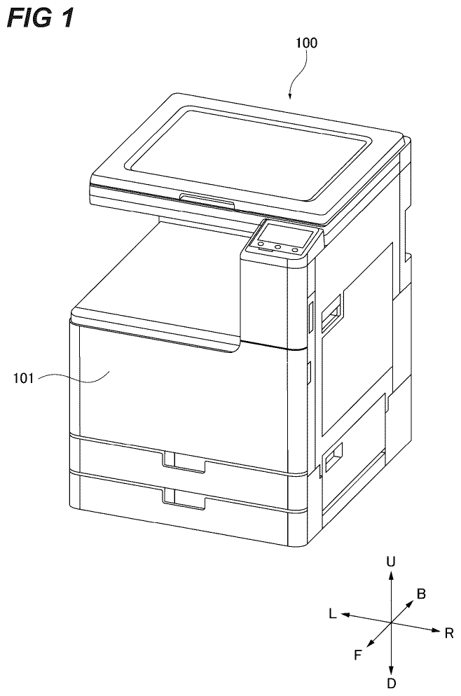

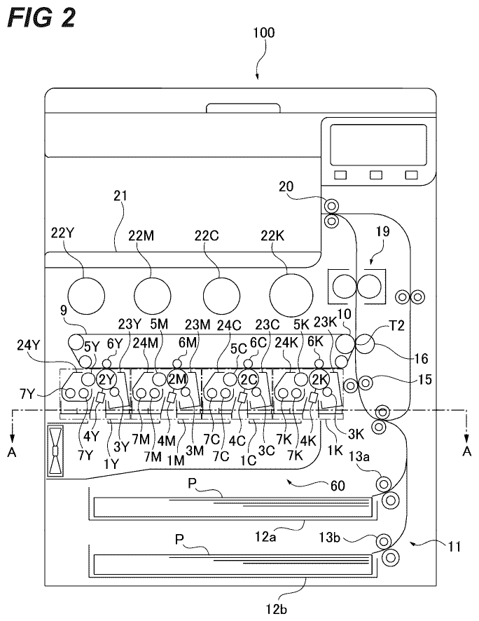

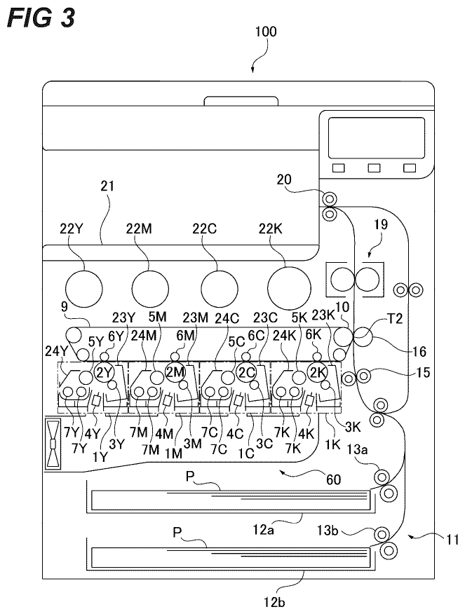

First, a schematic configuration of an image forming apparatus 100 is described with reference to FIGS. 1, 2, and 3. FIG. 1 is a perspective view of the image forming apparatus 100. FIGS. 2 and 3 are schematic cross-sectional views of the image forming apparatus 100 shown in FIG. 1. The image forming apparatus 100 shown in FIGS. 1 to 3 is a copying machine including a reading device, but the embodiment may be some other image forming apparatus such as a printer not including any reading device. The embodiment is not necessarily a color image forming apparatus including a plurality of photosensitive drums 2 as shown in FIGS. 2 and 3, and may be a color image forming apparatus including one photosensitive drum 2, or an image forming apparatus that forms monochrome images.

The image forming apparatus 100 shown in FIGS. 2 and 3 includes four image forming portions 1Y, 1M, 1C, and 1K (hereinafter also collectively referred to simply as the “image forming portions 1”) that form toner images of the respective colors of yellow, magenta, cyan, and black.

The image forming portions 1Y, 1M, 1C, and 1K include photosensitive drums 2Y, 2M, 2C, and 2K (hereinafter also collectively referred to simply as the “photosensitive drums 2”), respectively, which are an example of photosensitive members (image bearing members). These photosensitive drums are arranged apart from one another. The photosensitive drums may be photosensitive belts.

The image forming portions 1Y, 1M, 1C, and 1K include charging rollers 3Y, 3M, 3C, and 3K (hereinafter also collectively referred to simply as the “charging rollers 3”) as charging portions that electrically charge the photosensitive drums 2Y, 2M, 2C, and 2K, respectively.

The image forming portions 1Y, 1M, 1C, and 1K include exposure heads 4Y, 4M, 4C, and 4K (hereinafter also collectively referred to simply as the “exposure heads 4”) as exposure devices (exposure portions) that expose the photosensitive drums 2Y, 2M, 2C, and 2K.

Further, the image forming portions 1Y, 1M, 1C, and 1K include developing units 24Y, 24M, 24C, and 24K (hereinafter also collectively referred to simply as the “developing units 24”) as developing portions that develop electrostatic latent images on the photosensitive drums 2 with toner, and develop toner images in the respective colors on the photosensitive drums 2. Note that Y, M, C, and K attached to reference numerals represent the colors of the toner.

The image forming apparatus 100 shown in FIGS. 2 and 3 is an image forming apparatus that adopts a so-called “lower-side exposure system” that exposes the photosensitive drums 2 to light from below. In the image forming apparatus 100 adopting the lower-side exposure system, the exposure heads 4 are disposed under the photosensitive drums 2. In the following, the description is continued on the premise of an image forming apparatus that adopts the lower-side exposure system. Although not illustrated in the drawings, as an embodiment, an image forming apparatus adopting a “an upper-side exposure system” that exposes the photosensitive drums to light from above may be provided.

The image forming apparatus 100 includes an intermediate transfer belt 9 onto which the toner images formed on the photosensitive drums 2 are transferred, and primary transfer rollers 6 (Y, M, C, K) that sequentially transfer the toner images formed on the photosensitive drums 2 onto the intermediate transfer belt 9. The intermediate transfer belt 9 is disposed above the image forming portions 1. Other than the intermediate transfer system using the intermediate transfer belt 9, a direct transfer system for performing direct transfer from the photosensitive drums 2 onto a sheet may be used.

The image forming apparatus 100 also includes a secondary transfer roller 16 as a transfer portion that transfers the toner image on the intermediate transfer belt 9 onto a recording sheet P conveyed from a feeding portion 11, and a fixing device 19 as a fixing portion that fixes the secondarily-transferred image onto the recording sheet P. The secondary transfer roller 16 is brought into contact with a belt driving roller 10 of the intermediate transfer belt 9 with a predetermined pressing force via the intermediate transfer belt 9, to form a secondary transfer portion T2 together with the intermediate transfer belt 9.

Toner bottles 22Y, 22M, 22C, and 22K (hereinafter also collectively referred to simply as the “toner bottles 22”) that accommodate replenishment toners of the respective colors are detachable/replaceable units with respect to the image forming apparatus 100. The toner bottles 22 are disposed above the intermediate transfer belt 9. With the toner bottles 22, an appropriate amount of toner is supplied as appropriate from the corresponding toner bottles to the respective developing units of the four image forming portions by a toner supply mechanism (not shown).

The image forming apparatus 100 also includes the feeding portion 11 that feeds the recording sheet P. The feeding portion 11 includes sheet cassettes 12a and 12b, feeding rollers 13a and 13b, and a registration roller 15. The sheet cassettes 12a and 12b are disposed below the image forming portions 1. The recording sheets P accommodated in the sheet cassettes 12a and 12b are fed one by one by the feeding rollers 13a and 13b, and are conveyed to the secondary transfer portion T2 at a predetermined timing by the registration roller 15.

The image forming apparatus 100 also includes a duct unit 60 in a detachable manner. The duct unit 60 is disposed below the image forming portions 1, and above the feeding portion 11. The duct unit 60 is an exposure cooling unit that communicates with the exposure head 4 through a lifting and lowering duct 69 described later, and generates an air flow for cooling the exposure head 4.

### (Image Forming Process)

Next, an image forming process to be performed by the image forming apparatus 100 is briefly described. The charging roller 3Y electrically charges the surface of the photosensitive drum 2Y. The exposure head 4Y exposes the surface of the photosensitive drum 2Y charged by the charging roller 3Y. As a result, an electrostatic latent image is formed on the photosensitive drum 2Y. Next, the developing unit 24Y develops the electrostatic latent image formed on the photosensitive drum 2Y with yellow toner. The yellow toner image developed on the surface of the photosensitive drum 2Y is transferred onto the intermediate transfer belt 9 by the primary transfer roller 6Y. Magenta, cyan, and black toner images are also formed by the same image forming process, and are transferred onto the intermediate transfer belt 9 in a superimposing manner.

The toner images in the respective colors transferred onto the intermediate transfer belt 9 are conveyed to the secondary transfer portion T2 by the intermediate transfer belt 9. The toner images conveyed to the secondary transfer portion T2 are collectively transferred onto the recording sheet P conveyed from the feeding portion 11 by the secondary transfer roller 16. The recording sheet P onto which the toner image has been transferred is conveyed to the fixing device 19. The fixing device 19 fixes the toner image on the recording sheet P by heat and pressure. The recording sheet P subjected to the fixing process by the fixing device 19 is discharged onto a discharge tray 21 disposed above the toner bottles 22 by a discharge roller 20.

### (Drum Unit and Developing Unit)

Replaceable drum units 23 and the developing units 24 in the image forming apparatus 100 of the present embodiment are described by way of example.

Drum units 23Y, 23M, 23C, and 23K (hereinafter also collectively referred to simply as the “drum units 23”) including the photosensitive drums 2 are attached to the image forming apparatus 100. A drum unit 23 is a cartridge in which the photosensitive drum 2, the charging roller 3, and a cleaning device (not shown) are integrated, and is detached from the main body of the image forming apparatus 100 and is replaced by an operator such as a user or a maintenance person. The drum unit 23 rotatably supports the photosensitive drum 2. Specifically, the photosensitive drum 2 is rotatably supported by the frame body of the drum unit 23. Note that the drum unit 23 may not include the charging roller 3 or the cleaning device.

Also, the developing units 24Y, 24M, 24C, and 24K (hereinafter also collectively referred to simply as the “developing units 24”), which are independent of the drum units 23 as the photosensitive units, are attached to the image forming apparatus 100. The developing units 24 includes developing sleeves 5Y, 5M, 5C, and 5K (hereinafter also collectively referred to simply as the “developing sleeves 5”) as developer bearing members that bear the developer, and screws 7Y, 7M, 7C, and 7K (hereinafter also collectively referred to simply as the “screws 7”) that supply the developer to the developing sleeves 5 and stir the developer. A developing unit 24 is a cartridge in which the developing sleeve 5 and the screw 7 are integrated, and is detached from the main body of the image forming apparatus 100 and replaced by an operator.

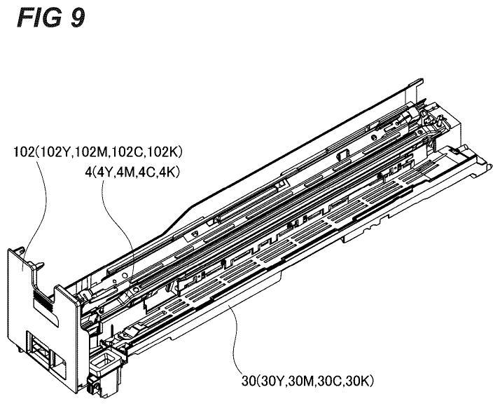

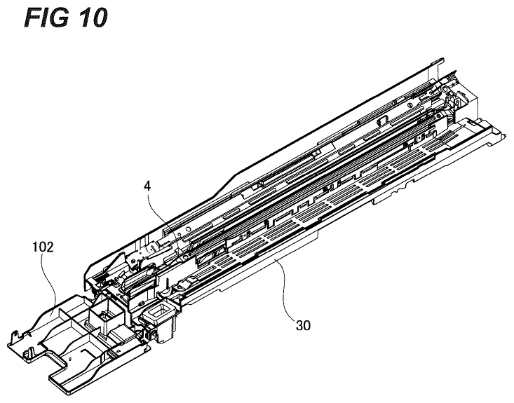

The image forming apparatus 100 also includes cartridge trays 30 (30Y, 30M, 30C, 30K) for the respective image forming portions (see FIGS. 9 and 10). The cartridge trays 30 support the drum units 23 and the developing units 24 for the respective image forming portions. The drum units 23 and the developing units 24 are guided in the axial direction of the photosensitive drums by the cartridge trays 30 for the respective image forming portions, and are inserted into and removed from the main body of the image forming apparatus 100.

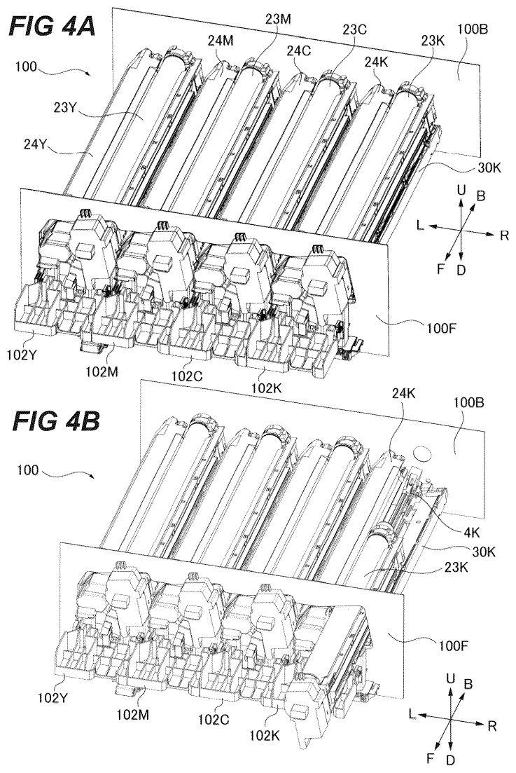

As illustrated in FIGS. 4A and 4A, one side of each cartridge tray 30 is attached to a front-side panel 100F, and the other side is attached to a back-side panel 100B, in the axial direction of the photosensitive drum. The front-side panel 100F is formed with a sheet metal, and forms part of the housing of the main body on the near side of the main body of the image forming apparatus 100. The back-side panel 100B is formed with a sheet metal, and forms part of the housing of the main body on the back side of the main body of the image forming apparatus 100. The front-side panel 100F and the back-side panel 100B are disposed to face each other at the one side and the other side in the axial direction of the photosensitive drum, and the two sides are bridged by a sheet metal (not shown) as a beam. The front-side panel 100F, the back-side panel 100B, and the beam (not shown) constitute part of the frame (housing) of the image forming apparatus. Here, regarding the image forming apparatus of the present embodiment or the constituent members thereof, the front side or the near side is the side on which the drum units 23 and the developing units 24 are taken in and out of (inserted into and removed from) the main body of the image forming apparatus 100.

The drum units 23 and the developing units 24 deteriorate due to repetition of the image forming process, and therefore, are in the form of units (cartridges) that can be maintained by replacement or attachment.

FIG. 3 shows the layout of the drum units 23, the developing units 24, and the exposure heads 4 at a time of replacement or attachment. Unlike the image forming apparatus illustrated in FIG. 2, the image forming apparatus illustrated in FIG. 3 has the developing units 24 and the exposure heads 4 retracted and separated from the photosensitive drums 2.

This is because, when a state in which the developing units 24 and the exposure heads 4 are disposed close to the photosensitive drums 2 as illustrated in FIG. 2 is maintained, each unit might be damaged due to dynamic interference at times of attachment and detachment of the unit, and furthermore, each unit might not be taken out of the apparatus.

Therefore, at a time of attachment or detachment of a unit, the developing units 24 and the exposure heads 4 are retracted and separated from the photosensitive drums 2 by a moving mechanism, as illustrated in FIG. 3.

Each of the drum units 23 and the developing units 24 is inserted into and removed from the near side of the image forming apparatus 100, and is mounted at a predetermined position (mounting position) in the main body of the image forming apparatus 100.

The image forming apparatus 100 includes inner doors 102Y, 102M, 102C, and 102K (hereinafter also collectively referred to simply as the “inner doors 102”) that cover the near sides of both the drum units 23 and the developing units 24 mounted at the mounting positions. The inner doors 102 are pivotally supported at the front sides of the cartridge trays 30, and are rotatable within predetermined ranges with respect to the cartridge trays 30. That is, the inner doors 102 are provided so as to be openable and closable with respect to the image forming apparatus.

Further, a front cover 101 forming part of the exterior of the apparatus is provided on the near side of the image forming apparatus 100. One end of the front cover 101 is fixed to the front side of the main body of the image forming apparatus 100 by a hinge, and is made rotatable with respect to the main body of the image forming apparatus 100 by the hinge. The front cover 101 is provided in front of the inner doors 102 in the axial direction of the photosensitive drums. In the closed state illustrated in FIG. 1, the front cover 101 covers the entire inner doors 102 arranged in a transverse direction to form part of the exterior on the front side of the apparatus.

In view of the above, the operation of replacing a drum unit 23 or a developing unit 24 is performed by an operator in the following order. The operator opens the front cover 101, next opens the inner door 102 as illustrated in FIGS. 4A and 4B, and takes out a drum unit 23 or a developing unit 24 in the apparatus main body. A new drum unit 23 or a new developing unit 24 is then inserted into the apparatus, the inner door 102 is closed, the front cover 101 is further closed, and thus, the replacement operation is completed.

Although not illustrated in the drawings, the image forming apparatus 100 according to the present embodiment includes a moving mechanism that moves the exposure heads 4 to the exposure positions or the retraction positions (separation positions) with respect to the photosensitive drums 2. The moving mechanism is provided in the image forming apparatus 100, and moves the exposure heads 4 to the exposure positions or the retraction positions at which the exposure heads 4 are retracted from the exposure positions.

In the present embodiment, the moving mechanism moves an exposure head 4 in the direction away from the corresponding photosensitive drum 2, and retracts the exposure head 4 to the retraction position, in conjunction with an operation of opening the inner door 102 as illustrated in FIG. 10. On the other hand, the moving mechanism moves an exposure head 4 in the direction toward the photosensitive drum 2, and moves the exposure head 4 to the exposure position, in conjunction with an operation of closing the inner door 102 as illustrated in FIG. 9.

In the present embodiment, the moving mechanism moves not only the exposure heads 4 but also the developing units 24 to the development positions or the retraction positions at which the developing units 24 are retracted from the development positions. That is, the moving mechanism moves a developing unit 24 in the direction away from the corresponding photosensitive drum 2, in conjunction with an operation of opening the inner door 102, and retracts the developing unit 24 to the retraction position. On the other hand, the moving mechanism moves a developing unit 24 in the direction toward the corresponding photosensitive drum 2, in conjunction with an operation of closing the inner door 102, and moves the developing unit 24 to the development position.

In the description below, the side of the front-side panel is defined as the front side (the near side or the front side), and the side of the back-side panel is defined as the back side (the deep side or the back surface side) with respect to the apparatus main body. Where the photosensitive drum 2K on which an electrostatic latent image related to a black toner image is formed is used as the reference, the side on which the photosensitive drum 2Y on which an electrostatic latent image related to a yellow toner image is formed is disposed is defined as the left side. Where the photosensitive drum 2Y on which an electrostatic latent image related to a yellow toner image is formed is used as the reference, the side on which the photosensitive drum 2K on which an electrostatic latent image related to a black toner image is formed is disposed is defined as the right side. Further, a direction that is perpendicular to a front-back direction and the transverse direction defined herein and is upward in the vertical direction is defined as the upward direction, and a direction that is perpendicular to the front-back direction and the transverse direction defined herein and is downward in the vertical direction is defined as the downward direction. The defined forward direction F, backward direction B, rightward direction R, leftward direction L, upward direction U, and downward direction D are shown in FIG. 1.

Furthermore, the axial direction of the photosensitive drums 2 mentioned in the following description is the direction that coincides with the front-back direction (near-far direction) shown in FIG. 1. Also, the longitudinal direction of the exposure heads 4 is the direction that coincides with the front-back direction shown in FIG. 1. That is, the axial direction of the photosensitive drums 2 and the longitudinal direction of the exposure heads 4 coincide with each other. Further, one side of the photosensitive drums 2 in the axial direction means the front side defined herein, and the other side means the back side defined herein. One side and the other side in the front-back direction also correspond to the front side and the back side defined here. One side in the transverse direction means the left side defined herein, and the other side means the right side defined herein.

### (Exposure Head)

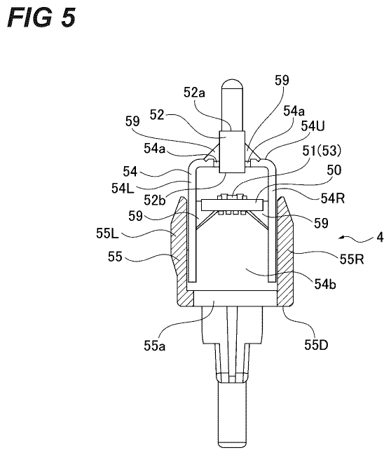

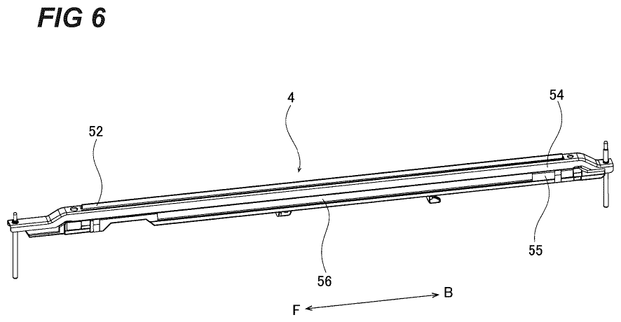

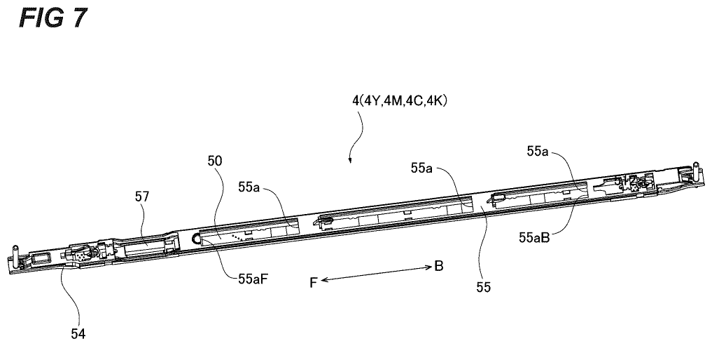

Next, an exposure head 4 is described with reference to FIGS. 5 to 7. FIG. 5 is a schematic cross-sectional view of an exposure head 4 included in the image forming apparatus of the present embodiment. FIG. 6 is a perspective view of the exposure head 4 as viewed from above. FIG. 7 is a perspective view of the exposure head 4 as viewed from below.

Here, as an example of an exposure system adopted in an electrophotographic image forming apparatus, there is a laser beam scanning exposure system that scans an irradiation beam of a semiconductor laser with a rotating polygon mirror or the like, and exposes the photosensitive drums via an f-θ lens or the like. The “exposure head 4” described in the present embodiment is used in an LED exposure system that exposes the photosensitive drum 2 using light emitting elements such as LEDs arranged in the rotational axis direction of the photosensitive drums 2, and is not used in the laser beam scanning exposure system.

As illustrated in FIGS. 6 and 7, the exposure head 4 has an elongated shape (longitudinal shape) extending in the axial direction of the photosensitive drum 2. As illustrated in FIG. 5, the exposure head 4 includes a substrate 50, a light emitting element mounted on the substrate 50, a lens array 52, a housing 54 that holds the substrate 50 and the lens array 52, and a housing support member 55 that supports the housing 54. Here, the exposure head 4 includes a light emitting diode (LED) 51 as a light emitting element that emits light.

### (Substrate and Lens Array)

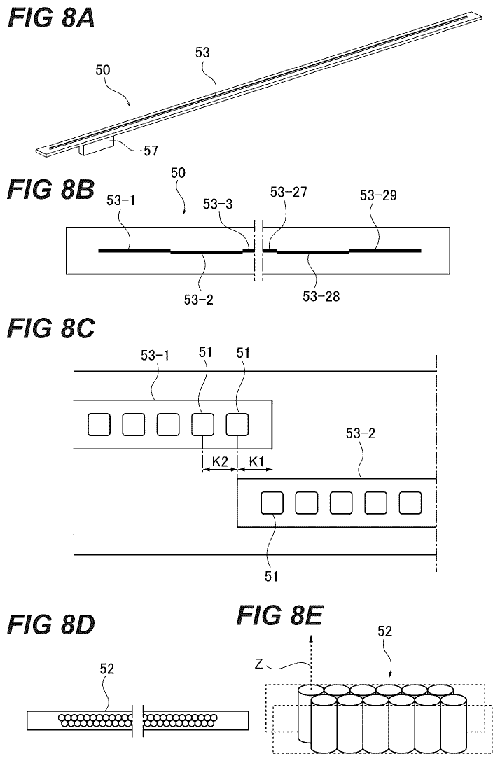

Referring now to FIGS. 8A to 8D, the substrate 50 and the lens array 52 of the exposure head 4 are described. First, the substrate 50 is described. FIG. 8A is a schematic perspective view of the substrate 50. FIG. 8B shows the layout of a plurality of LEDs 51 provided on the substrate 50, and FIG. 8C shows an enlarged view of FIG. 8B.

### (Substrate)

LED chips 53 are mounted on the substrate 50. As illustrated in FIG. 8A, the LED chip 53 is provided on one surface of the substrate 50, and a long connector 57 is provided on the other surface. Here, one surface of the substrate 50 is the surface (the top surface or the front surface) on the side on which the LED chips 53 are provided. The other surface of the substrate 50 is the surface (the lower surface or the back surface) opposite to the side on which the LED chips 53 are provided.

The connector 57 is attached to the other surface (the lower surface or the back surface) of the substrate 50 in such a manner that the longitudinal direction thereof coincides with the longitudinal direction of the substrate 50. The long connector 57 is provided on the front side of the image forming apparatus 100 (one side in the longitudinal direction of the substrate 50). Wiring lines for supplying signals to the respective LED chips 53 are provided on the substrate 50. One end of a flexible flat cable (not shown in the drawings, hereinafter abbreviated as FFC) as an example of a cable is connected to the connector 57.

Note that the control circuit portion of the image forming apparatus 100 has a substrate (not shown) including a controller and a connector. The other end of the FFC is connected to the connector. That is, the FFC electrically connects the substrate (control circuit portion) of the apparatus main body and the substrate 50 of the exposure head 4. A control signal (drive signal) is input to the substrate 50 of the exposure head 4 from the control circuit portion of the apparatus main body of the image forming apparatus 100 via the FFC and the connector 57. The control signal is transferred to each LED chip 53 mounted on the substrate 50. The LED chips 53 are driven (light emission or a light-off operation) by the control signal input to the substrate 50.

The LED chips 53 mounted on the substrate 50 are now described in greater detail. As illustrated in FIGS. 8B and 8C, LED chips 53-1 to 53-29 (29 chips) in which a plurality of LEDs 51 (an example of light emitting elements) is disposed are arranged on one surface of the substrate 50. In each of the LED chips 53-1 to 53-29, 516 LEDs 51 are arranged in the longitudinal direction. In the longitudinal direction of the LED chips 53, the center-to-center distance k2 between the adjacent LEDs 51 corresponds to the recording resolution of the image forming apparatus 100. The recording resolution of the image forming apparatus 100 of the present embodiment is 1200 dpi, and therefore, the LEDs 51 are arranged so that the center-to-center distance k2 of the adjacent LEDs 51 is 21.16 μm (micrometer) in the longitudinal direction of the LED chips 53-1 to 53-29. Because of this, the exposure range of the exposure head 4 of the present embodiment is about 314 mm (millimeter). The length of the photosensitive layer in the axial direction of the photosensitive drum 2 is 314 mm or longer. Since the length of the long side of an A4-size recording sheet and the length of the short side of an A3-size recording sheet are 297 mm, the exposure head 4 of the present embodiment has an exposure range in which an image can be formed on an A4-size recording sheet and an A3-size recording sheet.

The LED chips 53-1 to 53-29 are arranged in a staggered manner in the axial direction of the photosensitive drum 2. Specifically, the LED chips 53-1 to 53-29 are alternately arranged in two rows in the axial direction of the photosensitive drum 2. Specifically, as illustrated in FIG. 8B, odd-numbered LED chips 53-1, 53-3, . . . , and 53-29 counted from the left side are mounted in a row in the longitudinal direction of the substrate 50. Also, even-numbered LED chips 53-2, 53-4, . . . , and 53-28 counted from the right side are mounted in a row in the longitudinal direction of the substrate 50. The LED chips 53 are arranged in this manner. As a result, in the longitudinal direction of the LED chips 53, the center-to-center distance k1 between the LEDs 51 disposed at one end of one LED chip 53 and the other end of the other LED chip 53 in different LED chips 53 adjacent to each other can be made equal to the center-to-center distance k2 between adjacent LEDs 51 on one LED chip 53, as illustrated in FIG. 8C.

Although the light emitting elements are semiconductor LEDs that are light emitting diodes in the present embodiment, the light emitting elements may be organic light emitting diodes (OLEDs), for example. These OLEDs are also called organic electro-luminescence (EL), and are current-driven light emitting elements. The OLEDs are arranged in a line in the main scanning direction (the axial direction of the photosensitive drum 2) on a thin film transistor (TFT) substrate, for example, and are electrically connected in parallel by power supply wiring lines that are also provided in the main scanning direction.

### (Lens Array)

Next, the lens array 52 that is a lens assembly is described. FIG. 8D is a schematic view of the lens array 52 as viewed from the side of the photosensitive drum 2. FIG. 8E is a schematic perspective view of the lens array 52. As illustrated in FIG. 8D, the lens array 52 condenses light emitted from the light emitting elements onto the photosensitive drum 2. The lens array 52 is a lens assembly including a plurality of lenses. These lenses are arranged in two rows in the array direction of the plurality of LEDs 51. The respective lenses are alternately arranged so that one of the lenses in the other row is in contact with both of the adjacent lenses in the array direction of the lenses in one column. Each lens is a cylindrical glass rod lens, and has a light entrance surface 52b through which light that has exited from the LEDs 51 enters and a light exit surface 52a through which the light that has entered through the light entrance surface exits (see FIG. 5). The material of the lenses is not necessarily glass, and may be plastic. The shape of the lenses is not necessarily a cylindrical shape, and may be a polygonal prism such as a hexagonal prism.

A dotted line Z shown in FIG. 8E indicates the optical axis of a lens. The exposure head 4 is moved by the moving mechanism in a direction substantially along the optical axis of the lens indicated by the dotted line Z (hereinafter also referred to as the optical axis direction). The optical axis of a lens herein means the line connecting the center of the light exit surface of the lens and the focal point of the lens. The lens array 52 is a lens assembly including a plurality of lenses, and the “optical axis” described above is the optical axis of a lens among the plurality of lenses. Here, strictly speaking, the plurality of lenses included in the lens array 52 may be slightly inclined with respect to one another. This is due to tolerance during the assembling. However, the deviation such as the tolerance herein is not taken into consideration in a case where the direction of the optical axis is defined. Therefore, it is considered that the optical axes of the plurality of lenses extend in the same direction. Radiation light emitted from the LEDs 51 enters the lens included in the lens array 52. The lenses have a function of condensing the incident radiation light onto the surface of the photosensitive drum 2.

The attachment position of the lens array 52 with respect to the housing 54 is adjusted at the time of assembling of the exposure head 4 so that the distance between the light emitting surfaces of the LEDs 51 and the light entrance surfaces 52b of the lenses is substantially equal to the distance between the light exit surfaces 52a of the lenses and the surface of the photosensitive drum 2.

### (Housing)

As illustrated in FIG. 5, the housing 54 holds the lens array 52 and the substrate 50. In the present embodiment, the housing 54 is a metal member formed by bending a plate material obtained by plating a galvanized steel plate or a cold-rolled steel plate. For example, the housing 54 is formed by pressing a sheet metal such as an iron thin plate into a U-like shape.

The housing 54 has a planar portion (an opposed face) 54U in which a first opening 54a into which the lens array 52 is inserted is formed. The planar portion 54U faces the photosensitive drum 2 in the optical axis direction of the lens of the lens array 52. Note that the planar portion 54U is not necessarily a flat surface, and may be a slightly curved surface. The housing 54 has an extending portion 54R extending in a direction away from the photosensitive drum 2 from one side in the lateral direction of the planar portion 54U. The housing 54 also has an extending portion 54L extending in a direction away from the photosensitive drum 2 from the other side in the lateral direction of the planar portion 54U.

The extending portion 54R and the extending portion 54L form substrate support portions for supporting the substrate 50 inserted through a second opening 54b in the housing 54. The planar portion 54U and the substrate support portions (the extending portions 54R and 54L) are integrated to form the housing 54 that holds the lens array 52 and the substrate 50, and a cross-section thereof is formed in a substantially U-like shape. As the housing 54 is formed in a substantially U-like shape, the second opening 54b is formed on the opposite side from the planar portion 54U. The second opening 54b is formed between the substrate support portions (the extending portions 54L and 54R) extending from the planar portion 54U to the side away from the photosensitive drum 2. That is, the second opening 54b of the housing 54 is formed between the substrate support portions (the extending portions 54R and 54L) that support one side and the other side of the substrate 50 in a direction orthogonal to the optical axis direction and the axial direction.

The first opening 54a (a lens attachment portion) of the housing 54 is an opening slightly larger than the lens array 52, and the lens array 52 is bonded and fixed to the housing 54 with an adhesive (not shown). Further, the substrate 50 is formed in a size slightly smaller than the housing 54, and the position of the substrate 50 is adjusted so that the optical axis of the LED 51 is aligned with the center of the lens array 52. After that, the substrate 50 is bonded and fixed to the housing 54 with an adhesive (not shown) between wall surfaces existing on both sides of the substrate 50 in the lateral direction (the direction orthogonal to the longitudinal direction) of the housing 54. The adhesive is an ultraviolet curable adhesive, for example, and is cured after applied to an adhesion site while in a liquid or gel state and then irradiated with ultraviolet rays.

At the time of assembling of the exposure head 4, the substrate 50 bonded and fixed to the housing 54 further seals the gap from the housing 54 with a sealant 59. As described above, the lens array 52 is also bonded and fixed to the housing 54 with an adhesive, like the substrate 50. The gap between the lens array 52 and the housing 54 is also sealed by the sealant 59.

The sealant 59 performs sealing, using a moisture-curable silicone resin. The sealant 59 is not necessarily a moisture-curable resin, and may be a photocurable adhesive, a foamed sealing material formed with a sponge material, or the like.

### (Housing Support Member)

The housing support member 55 supports the housing 54 that holds the substrate 50 and the lens array 52. One end and the other end of the housing support member 55 in the longitudinal direction are fixed to the housing 54 by a joining material such as an ultraviolet curable adhesive, and are provided integrally on the housing 54. The housing support member 55 is a member having an elongated shape extending in the axial direction of the photosensitive drum 2. The housing support member 55 is formed in a U-like shape. The housing support member 55 includes a right sidewall 55R that is a first opposed portion, a left sidewall 55L that is a second opposed portion facing the right sidewall 55R with the housing 54 interposed in between, and a bottom face portion 55D that is disposed between the right sidewall 55R and the left sidewall 55L and faces the planar portion 54U of the housing 54. The bottom face portion 55D, the right sidewall 55R, and the left sidewall 55L are integrated, and constitute the housing support member 55 that forms a duct with the housing 54, and a cross-section thereof is formed in a substantially U-like shape. The bottom face portion 55D of the housing support member 55 has a plurality of openings 55a formed in the longitudinal direction, which is the axial direction of the photosensitive drum 2.

The openings 55a of the housing support member 55 are provided at positions facing the surface of the substrate 50 (the back surface of the substrate 50) opposite from the mounting surface (the front surface of the substrate 50) on which the LEDs 51 are mounted. The openings 55a is provided between the right sidewall 55R and the left sidewall 55L in the lateral direction orthogonal to the longitudinal direction.

The right sidewall 55R is the first opposed portion facing the extending portion 54R that is the substrate support portion on one side of the housing 54 in the lateral direction. As illustrated in FIG. 5, the right sidewall 55R, which is the first opposed portion, is provided between the housing 54 and the drum unit 23 that is a portion adjacent to the housing 54 on one side in the lateral direction orthogonal to the axial direction of the photosensitive drum 2. The right sidewall 55R is provided in the axial direction of the photosensitive drum 2 so as to separate the housing 54 and the drum unit 23 from each other.

The left sidewall 55L is the second opposed portion that faces the left sidewall 55L, which is the substrate support portion on the other side of the housing 54 in the lateral direction, and faces the right sidewall 55R on the opposite side of the housing 54. As illustrated in FIG. 5, the left sidewall 55L, which is the second opposed portion, is provided between the housing 54 holding the substrate 50 and the developing unit 24, which is a developing portion, on the other side in the lateral direction. Like the right sidewall 55R, the left sidewall 55L is provided in the axial direction of the photosensitive drum 2 so as to separate the housing 54 and the developing unit 24 from each other.

As the housing support member 55 is provided integrally on the housing 54, an airflow sent from the duct unit 60 is blown onto the back surface of the substrate 50 through the openings 55a of the housing support member 55. Moreover, the airflow blown onto the back surface of the substrate 50 is blown in a direction orthogonal to the back surface of the substrate 50.

As described above, the housing support member 55 is provided in the longitudinal direction, which is the axial direction of the photosensitive drum 2, and has the openings 55a at positions facing the back surface of the substrate 50. Thus, an airflow sent from the duct unit 60 is blown onto the back surface of the substrate 50 through the openings 55a of the housing support member 55. The housing support member 55 of the exposure head 4 forms a duct (a closed space) between the housing 54 and the housing support member 55, and the duct circulates an airflow blown onto the back surface of the substrate 50 through the openings 55a, in the longitudinal direction of the substrate 50. That is, the housing support member 55 forms part of the duct that cools the exposure head 4.

As described above, the exposure head 4 is formed as an integrated head unit with the substrate 50 including the LEDs 51, the lens array 52 including a plurality of lenses, the housing 54, and the housing support member 55.

### (Moving Mechanism)

The moving mechanism of the exposure head 4 includes a lifting and lowering duct 69, rotating arms 65, and a link member (not shown). In the present embodiment, the moving mechanism moves not only the exposure head 4 but also the developing unit 24 to the development position or the retraction position at which the developing unit 24 is retracted from the development position. The configuration of the moving mechanism is an example, and is not limited to this.

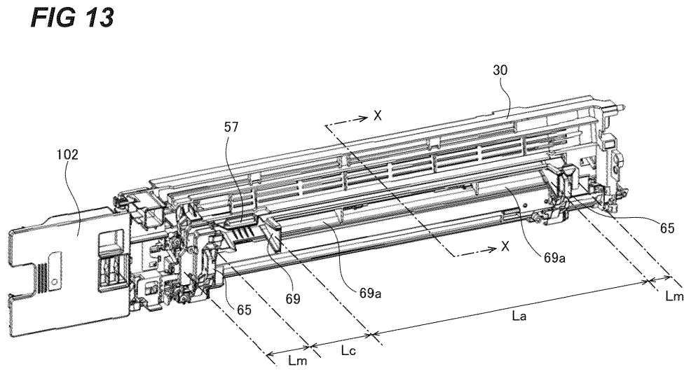

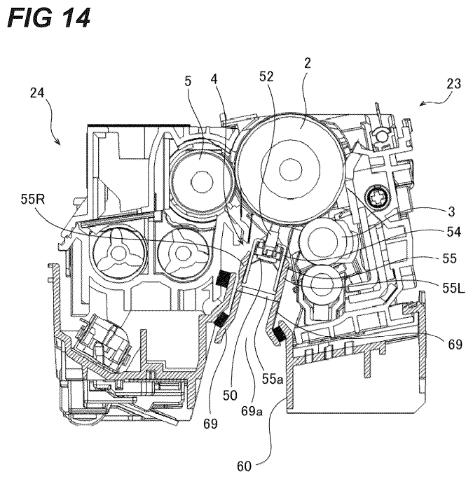

Referring now to FIGS. 13 and 14, the moving mechanism including the lifting and lowering duct 69 and the rotating arms 65 is described. FIG. 13 is a perspective view of the cartridge tray as viewed from the lower surface. FIG. 14 is a cross-sectional view of the exposure head as viewed in the direction indicated by the line X-X defined in FIG. 13, as viewed from the front.

The lifting and lowering duct 69 is an exposure support member that detachably supports the exposure head 4, and is provided in the main body of the image forming apparatus 100 together with the cartridge tray 30.

The lifting and lowering duct 69 is provided at a tray center portion corresponding to a portion between a development support portion that supports the developing unit 24 of the cartridge tray 30 and a drum support portion that supports the drum unit 23. The lifting and lowering duct 69 is provided at the tray center portion of the cartridge tray 30 so as to be able to move to an exposure position at which the photosensitive drum 2 is exposed and a retraction position at which the lifting and lowering duct 69 is retracted from the exposure position. Both end portions of the lifting and lowering duct 69 in the longitudinal direction are supported from below by the rotating arms 65. The lifting and lowering duct 69 is moved in a direction (a moving direction) orthogonal to the axial direction of the photosensitive drum 2 by the rotating arms 65, integrally with the exposure head 4. The lifting and lowering duct 69 is moved to the exposure position or the retraction position by rotation of the rotating arms 65.

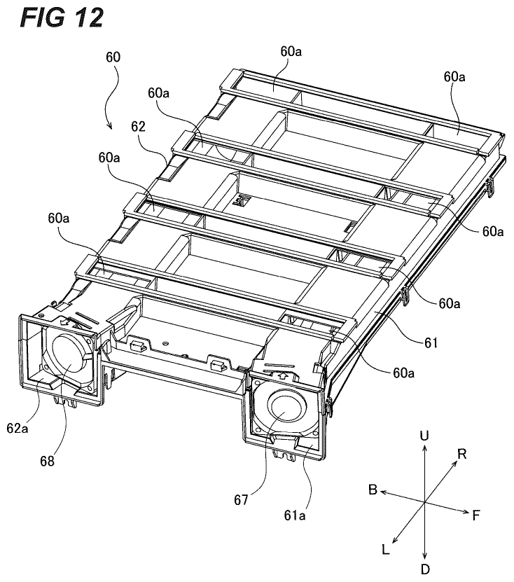

The lifting and lowering duct 69 has an elongated shape extending in the front-back direction (the axial direction of the photosensitive drum) like the exposure head 4, so as to be able to support the entire exposure head 4, and a central portion thereof has a shape having openings at upper and lower portions. In the lifting and lowering duct 69, one opening (not shown) communicates with the openings 55a of the exposure head 4, and the other opening 69a (see FIG. 13) communicates with an opening 60a (see FIG. 12) of the duct unit 60. The lifting and lowering duct 69 supports the exposure head 4, and, at the same time, forms part of a duct (a closed space) that connects the exposure head 4 and the duct unit 60 to form a flow channel of an airflow for cooling the exposure head 4.

Accordingly, the lifting and lowering duct 69 causes an airflow generated by the duct unit 60 to flow to the back surface of the substrate 50 of the exposure head 4 through the above-described upper and lower openings. Thus, the lifting and lowering duct 69 can circulate the airflow by the duct unit 60 to the back surface of the substrate 50 of the exposure head 4 without leaking the airflow to the adjacent developing unit 24 and drum unit 23, and reduce the scattering of the toner inside the apparatus.

Further, the rotating arms 65 that move the exposure head 4 to an exposure position close to the photosensitive drum 2 and a retraction position at which the exposure head 4 is retracted from the exposure position are disposed at both end portions of the lifting and lowering duct 69 in the longitudinal direction. The rotating arms 65 are rotatably provided on the developing unit side of the cartridge tray 30. One end portion of each rotating arm 65 in the transverse direction orthogonal to the axial direction of the photosensitive drum 2 is rotatably supported about an axis parallel to the axial direction. The other end portions of the rotating arms 65 in the transverse direction support both end portions of the lifting and lowering duct 69 in regions (ranges Lm in FIG. 13) outside the openings of the lifting and lowering duct 69 in the axial direction. The rotating arm 65 is designed to interlock with opening and closing of the inner door 102 by the link member (not shown).

In the lifting and lowering duct 69 shown in FIG. 13, the range of the opening forming the duct is denoted by La, and the ranges of the positions of the rotating arms 65 are denoted by Lm. The range La of the opening of the lifting and lowering duct 69 is provided between the ranges Lm of the positions of the rotating arms 65.

A range Lc in FIG. 13 is the region in which the connector 57 of the exposure head 4 is provided, and is located outside the duct region indicated by the range La in FIG. 13 and between the duct region and the region indicated by one of the ranges Lm in FIG. 13.

The range La forming the duct includes most of the substrate 50 on which the LEDs 51 are mounted, and the exposure head 4 can be sufficiently cooled by blowing an airflow to the range La. Note that the range Lc is the mounting portion for the connector 57 of a signal line that transmits a drive signal to the substrate 50 having the LEDs 51 mounted thereon. The range Lc does not have any opening forming the duct, but is designed to enable desirable and sufficient cooling in the range La as described above.

Thus, air taken in from the outside of the apparatus by the duct unit 60 is blown onto the back surface of the substrate 50 from the openings 55a of the exposure head 4 through the lifting and lowering duct 69. Also, an airflow blown onto the back surface of the substrate 50 from the openings 55a of the exposure head 4 is discharged to the outside of the apparatus through the lifting and lowering duct 69 by the duct unit 60.

### (Duct Unit)

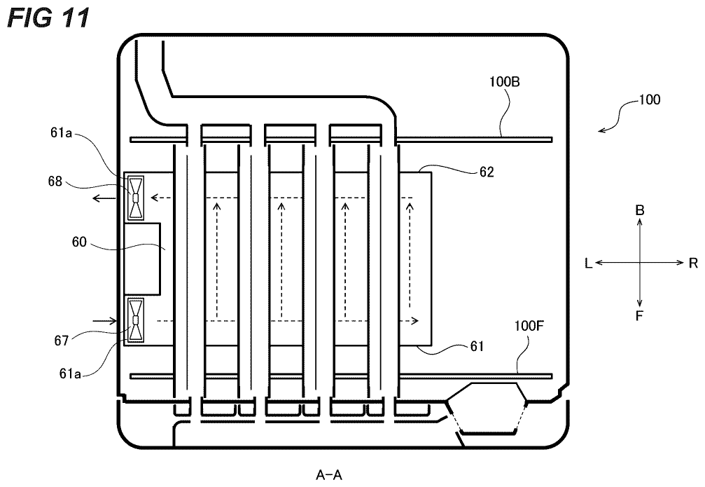

The image forming apparatus 100 also includes the duct unit 60 in a detachable manner. Referring now to FIGS. 11 and 12, the duct unit 60 is described. FIG. 11 is a cross-sectional view of the image forming apparatus taken along the line A-A defined in FIG. 2. FIG. 12 is a perspective view of the duct unit as viewed from above.

The duct unit 60 is an exposure cooling unit that communicates with the opening 69a formed by the cartridge tray 30 and the lifting and lowering duct 69, and cools the exposure head 4 by an airflow through the lifting and lowering duct 69.

The duct unit 60 includes an exhaust air duct 62 that communicates with the lifting and lowering duct 69, and forms a space through which air introduced from the lifting and lowering duct 69 flows. On an upper surface of the exhaust air duct 62, the openings 60a that communicate with the lifting and lowering duct 69 and introduce air from the lifting and lowering duct 69 are provided for the respective exposure heads. The exhaust air duct 62 has a fan 68 that generates an airflow.

The duct unit 60 includes an air intake duct 61 that communicates with the lifting and lowering duct 69, and forms a space through which air to be introduced into the lifting and lowering duct 69 flows. On an upper surface of the air intake duct 61, the openings 60a that communicate with the lifting and lowering duct 69 and introduce air into the lifting and lowering duct 69 are provided for the respective exposure heads. The air intake duct 61 has a fan 67 that generates an airflow.

The duct unit 60 is integrally formed with the fans 67 and 68, the air intake duct 61, and the exhaust air duct 62, and is detachably attached to the main body of the image forming apparatus 100 at a portion immediately below the cartridge tray 30.

Each opening 60a of the duct unit 60 is provided at a position facing the opening 69a of the lifting and lowering duct 69 for each corresponding exposure head, and is connected to the opening 69a to communicate with the exposure head 4 and form a closed space.

### (Cooling Configuration for Exposure Heads)

Referring now to FIGS. 11 to 14, a cooling configuration for the exposure heads is described. In FIG. 11, a flow of air for cooling the exposure heads is indicated by dashed lines, and the flow of air indicated by the dashed lines is also referred to as an exposure cooling airflow.

The exposure heads 4 dissipate heat depending on the amount of light emission from the LEDs 51, and are disposed close to the development devices using toner that is weak against heat. Therefore, a cooling portion is used. In particular, in a case where an image forming process is repeated at a high frequency, which is a case where the image forming process is used in an apparatus having high productivity, or in a case where images having high density are successively output, the light emission time is long, and the amount of light emission is large accordingly. Therefore, the amount of heat generated from the LEDs 51 and the circuit on the substrate 50 having the LEDs 51 mounted thereon is also large.

As a countermeasure against this, the housing 54 of each exposure head 4 is also used as a heatsink, for example, and each exposure head 4 is designed to easily dissipate heat and hardly store heat. However, even in such a case, it is conceivable that the cooling of the exposure heads 4 is too slow, heat accumulation proceeds, and the heat dissipated to the surroundings also increases. As a result, the toner around the developing units 24 and part of the circulating toner inside the developing units 24 may be fused, leading to an image defect.

Even in a case where a configuration for cooling the developing units 24 is provided, it is easily assumed that the heat accumulation caused by the light emission from the LEDs 51 is dominant at portions near the exposure heads 4. Therefore, it is desirable to provide a cooling configuration (an exposure cooling airflow) for the exposure heads 4 to reduce the amount of heat to be dissipated in the surroundings of the exposure heads 4.

The image forming apparatus 100 includes the exposure heads 4, the lifting and lowering duct 69, the cartridge tray 30, and the duct unit 60. The exposure heads 4 are mounted on the lifting and lowering duct 69 disposed in the image forming apparatus 100, and is integrated with the lifting and lowering duct 69. As the exposure heads 4 are mounted on the lifting and lowering duct 69, the openings 55a (see FIG. 7) of the housing support member 55 of the exposure heads 4 communicate with one opening (not illustrated) of the lifting and lowering duct 69. The lifting and lowering duct 69 forms a duct that allows each exposure head 4 and the duct unit 60 to communicate with each other. The duct unit 60 is mounted immediately below the cartridge tray 30 with respect to the image forming apparatus 100. In other words, the duct unit 60 is provided on the opposite side of the exposure heads 4 from the photosensitive drums 2. As the duct unit 60 is mounted in the image forming apparatus 100, the openings 60a (see FIG. 12) of the duct unit 60 communicate with the other opening 69a (see FIG. 13) of the lifting and lowering duct 69.

In this manner, the housing support member 55 of each exposure head 4, the lifting and lowering duct 69, the cartridge tray 30, and the duct unit 60 constitute a cooling duct that is a continuous closed space. Each exposure head 4 is cooled by an exposure cooling airflow (dashed lines shown in FIG. 11) flowing in the one closed space formed by the housing support member 55, the lifting and lowering duct 69, the cartridge tray 30, and the duct unit 60.

As illustrated in FIGS. 11 and 12, the fan 67 disposed closer to the front side of the apparatus functions as an air intake fan that takes air (fresh air) from the outside of the apparatus into the duct unit 60. The fan 68 disposed closer to the back side of the apparatus functions as an exhaust air fan that exhausts air from the inside of the duct unit 60 to the outside of the apparatus.

In the exposure cooling airflow indicated by dashed lines in FIG. 11, when the fan 67 and the fan 68 rotate, air outside the apparatus is introduced from an air inlet 61a through a louver (not shown) provided in the exterior cover of the image forming apparatus. The air introduced from the air inlet 61a is discharged from each opening 60a of the air intake duct 61 through the air intake duct 61. The air discharged from the respective openings 60a is blown onto the exposure heads 4 through the lifting and lowering duct 69. The air blown onto the exposure head 4 through the lifting and lowering duct 69 flows from the apparatus front side to the apparatus back side in the axial direction of the photosensitive drums 2, and is introduced into the exhaust air duct 62 from each opening 60a of the exhaust air duct 62 through the lifting and lowering duct 69. The air introduced from each opening 60a into the exhaust air duct 62 is discharged from an air outlet 62a of the exhaust air duct 62 to the outside of the apparatus through a louver (not illustrated) provided in the exterior cover.

The fans 67 and 68 in the duct unit 60 are controlled based on temperature detection sensors (not shown) disposed on the substrates 50 for the respective colors. Thus, the fans are not always rotating, but start rotating when the temperature detected by the temperature detection sensors reaches a predetermined threshold. As described above, the operation of the exposure cooling flow by the fans is minimized, and the air volume is also minimized, so that the possibility of toner scattering to the inside of the apparatus is lowered also from the controlling point of view.

(Configuration to Prevent Airflow in Exposure Head from Outflowing)

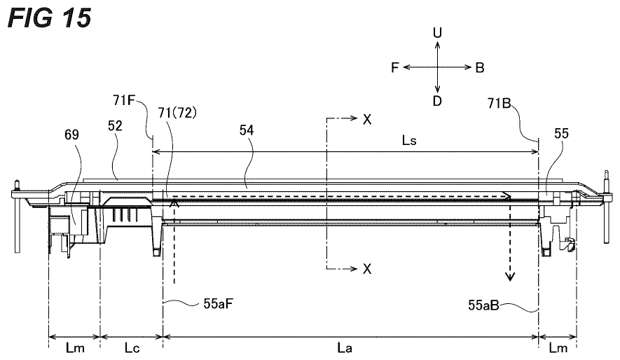

Referring next to FIGS. 15 to 18, a flow channel of an airflow in each exposure head 4 and a configuration for preventing the airflow from outflowing are described.

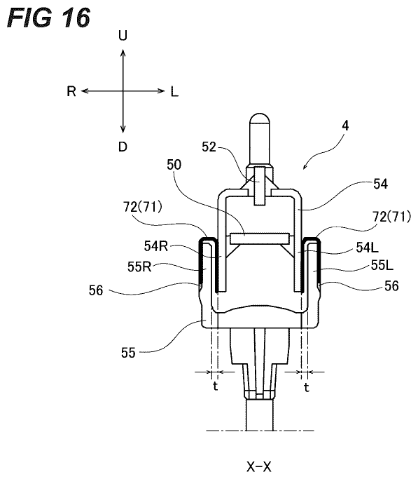

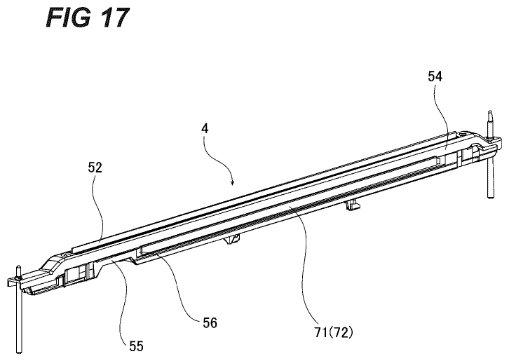

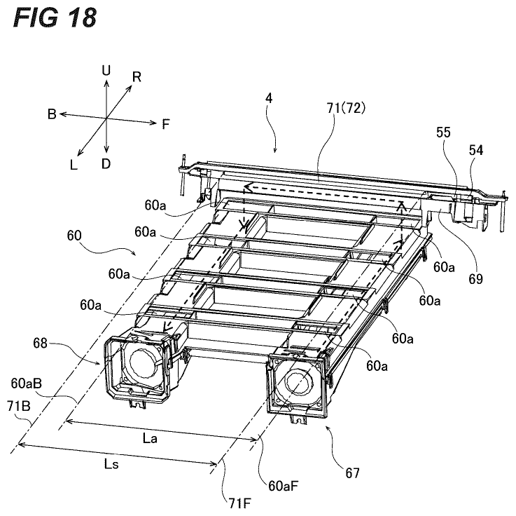

FIG. 15 is a diagram showing the longitudinal lengths of the sheet and the opening of an exposure head according to the first embodiment. FIG. 16 is a cross-sectional view of the exposure head according to the first embodiment, and is a cross-sectional view of the exposure head taken along the line X-X defined in FIG. 15, showing substantially the center of the exposure head in the longitudinal direction. Although FIG. 16 shows the lifting and lowering duct and the exposure head, FIG. 15 shows only the exposure head. FIG. 17 is a perspective view of the exposure head according to the first embodiment, and FIG. 18 is a perspective view of the exposure head, the lifting and lowering duct, and the duct unit according to the first embodiment.

In the exposure head 4, temperature rise due to heat generation from the substrate 50 is a problem. Therefore, in the exposure head 4, the temperature rise is suppressed by causing an airflow in the space covered by the substrate 50, the housing 54, and the housing support member 55. However, there is a slight gap between the housing 54 and the housing support member 55. This gap exists as a gap t in the transverse direction (arrow direction) in FIG. 16, and is a useful gap from the viewpoint of assembling properties and component precision. From the viewpoint of assembling properties, in the absence of this gap t, when the housing 54 and the housing support member 55 are assembled in the vertical direction in FIG. 16, one or both of the housing 54 and the housing support member 55 are assembled while being deformed in the transverse direction. In this case, there is a risk of affecting the optical system such as the substrate 50 and the lens array 52. From the viewpoint of component precision, the housing 54 and the housing support member 55 as a whole have an elongated shape in the front-back direction (axial direction), and a predetermined amount of warpage might occur in the process of component manufacture. As can be seen from the above, a predetermined gap t is used between the housing 54 and the housing support member 55 to absorb dimensional tolerance including warpage of the components or the like and perform assembling without deformation. However, from the viewpoint of the airflow for cooling the exposure head 4, the gap t is not desirable, and there is a possibility that toner, minute dust, and the like are scattered due to blowing or suction from through gap t. As a result, scattered toner and minute dust might adhere to the surface of the lens array 52 and cause image defects.

Therefore, in the present embodiment, to reduce scattering of foreign matter such as toner due to outflowing of the airflow through the gap t, the gap t between the housing 54 and the housing support member 55 constituting the exposure head 4 is sealed with a sealing member 71, as illustrated in FIG. 16.

The sealing member 71 seals the gap t between the housing 54 and the housing support member 55 facing each other on one side and the other side of the substrate 50 in the transverse direction (the directions of arrows shown in FIG. 16) orthogonal to the optical axis direction and the axial direction.

As described above, the housing 54 has the second opening 54b, and holds the substrate 50 and the lens array 52. The housing support member 55 is provided integrally on the housing 54 so as to cover the second opening 54b of the housing 54, and forms a space for circulating air between the housing 54 and the housing support member 55.

The second opening 54b of the housing 54 is formed between the extending portions 54R and 54L, which are the substrate support portions that support one side and the other side of the substrate 50 in the transverse direction. The housing support member 55 includes the right sidewall 55R that faces the extending portion 54R on one side of the housing 54 in the transverse direction, and the left sidewall 55L that faces the extending portion 54L on the other side of the housing 54, and faces the right sidewall 55R, with the housing 54 interposed in between.

The sealing member 71 seals the gap t between the extending portion 54R on the one side and the right sidewall 55R that face each other in the transverse direction, and the gap t between the extending portion 54L on the other side and the left sidewall 55L that face each other in the axial direction (the front-back direction). As a result, the sealing member 71 can prevent the airflow from outflowing through the gaps t at two portions in the transverse direction of the housing 54 and the housing support member 55 as shown in FIGS. 17 and 18, and can reduce scattering of foreign matter such as toner due to outflow of the airflow.

As described above, the housing support member 55 has a plurality of openings 55a (see FIG. 7) communicating with the duct unit 60 that generates the airflow for cooling the exposure head 4. The housing support member 55 circulates air in the space formed between the housing 54 and the housing support member 55 through the openings 55a. Further, the openings 55a of the housing support member 55 are provided at positions facing the surface on the opposite from the surface of the substrate 50 that has the LEDs 51 mounted thereon and is held by the housing 54 (see FIG. 5).

The sealing member 71 is longer than the length from one end portion 55aF to the other end portion 55aB of the region in which the plurality of openings 55a of the housing support member 55 is provided in the axial direction (see FIGS. 7 and 15). Note that the range from the one end portion 55aF to the other end portion 55aB, which is the region in which the plurality of openings 55a is provided, is the same range as the range La of the opening of the lifting and lowering duct 69 shown in FIG. 13. That is, the length Ls from one end 71F to the other end 71B of the sealing member 71 in the axial direction is longer than the range La from the one end portion 55aF to the other end portion 55aB, which is the region in which the plurality of openings 55a of the exposure head 4 is provided.

In other words, as illustrated in FIG. 18, it can be said that the length Ls of the sealing member 71 in the axial direction is longer than the range La, which is the region in which the openings 60a of the duct unit 60 are provided. As described above, the opening of the lifting and lowering duct 69 also communicates with the openings 60a of the duct unit 60. Note that the range from one end portion 60aF to the other end portion 60aB, which is the region in which the openings 60a of the duct unit 60 are provided, is the same range as the range La of the opening of the lifting and lowering duct 69 shown in FIG. 13. Therefore, it can also be said that the length Ls from one end 71F to the other end 71B of the sealing member 71 in the axial direction is longer than the range La from the one end portion 60aF to the other end portion 60aB, which is the region in which the openings 60a of the duct unit 60 are provided.

The sealing member 71 is a sheet member. Hereinafter, the sealing member 71 will be also referred to as a sheet member 72.

With the above configuration, the range Ls of the sheet member 72 covers the entire opening range La, and the sheet member 72 can prevent the airflow from outflowing through the gap t of the exposure head 4.

One side of the sheet member 72 in the transverse direction is bonded to and held by the housing support member 55, and the other side is bent toward the gap between the housing 54 and the housing support member 55, is inserted into the gap t, and is brought into contact with the housing 54 by a reaction force generated at the time of the bending.

As illustrated in FIG. 16, the sheet member 72 is bent from bonding portions 56 of the housing support member 55, and abuts on the housing 54. As the sheet member 72 is bent, the housing 54 on which the sheet member 72 abuts continues to receive the reaction force of the sheet member 72. With this configuration, outflowing of the airflow due to deflection, waviness, or the like of the sheet member 72 is reduced, and the sheet member 72 and the housing 54 reliably abut on each other at the gap t.

Here, in a case where the thickness of the sheet member 72 is small, there is a possibility that the risk of occurrence of deflection, waviness, or the like when the sheet member 72 is bent will be higher. On the other hand, in a case where the thickness of the sheet member 72 is great, the reaction force continuously received by the housing 54 increases, and there is a risk of affecting the optical system such as the substrate 50 and the lens array 52 held by the housing 54. Therefore, it is useful to select an appropriate thickness for the sheet member 72.

In view of the above, a polyester film having a thickness of 100 μm or smaller is used for the sheet member 72 in the present embodiment. For example, Lumirror S10, which is polyester film manufactured by Toray Industries, Inc., is used as the sheet member 72, and the thickness thereof is 38 μm.

Although the sheet member 72 is bent and inserted into the gap t, and abuts on the housing in the above description, the sheet member 72 may abut on both the housing 54 and the housing support member 55.

Specifically, the housing support member 55 includes the bonding portions 56 that bond the sheet member 72 to the surface on the opposite side from the surface facing the housing 54 in the transverse direction. The bonding portions 56 are provided on the respective outer surfaces of the right sidewall 55R and the left sidewall 55L of the housing support member 55. The bonding portions 56 each have a recessed shape (a step-like shape) toward the housing in the transverse direction, unlike portions of the housing support member 55 adjacent to the bonding portions 56. The bonding portions 56, which are recesses, are larger recesses than the thickness of the sheet member 72 in the transverse direction. Therefore, even when the sheet member 72 is bonded by the bonding portions 56 of the respective sidewalls of the housing support member 55, the sheet member 72 does not protrude outward from the portions adjacent to the bonding portions 56. As a result, when the exposure head 4 is moved to the exposure position or the retraction position, the sheet member 72 is prevented from being caught around the exposure head 4, and being curled or peeled off.

### Second Embodiment

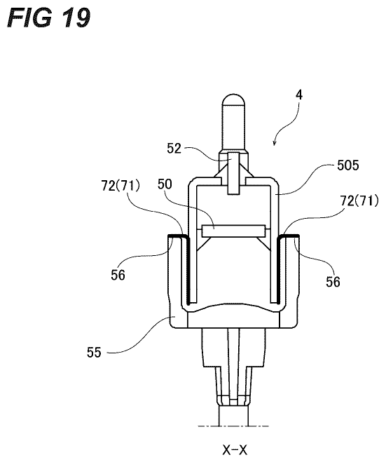

Referring now to FIG. 19, an exposure head 4 according to a second embodiment is described. FIG. 19 is a cross-sectional view of the exposure head 4 according to the second embodiment. Note that schematic configurations of the exposure head 4 and an image forming apparatus 100 are substantially the same as those of the first embodiment described above, and therefore, members having equivalent functions are denoted by the same reference numerals as those used in the first embodiment, and explanation thereof is not made herein.

As illustrated in FIG. 19, one side of a sheet member 72 is bonded to and held by the upper surfaces of a right sidewall 55R and a left sidewall 55L of a housing support member 55. That is, in the present embodiment, bonding portions 56 are provided on the respective upper surfaces of the right sidewall 55R and the left sidewall 55L of the housing support member 55. In the configuration of the present embodiment, the sheet member 72 is bent from the bonding portions 56 of the housing support member 55, is inserted into the gap t, and abuts on the housing 54. As the sheet member 72 is bent in such a manner, the housing 54 on which the sheet member 72 abuts continues to receive the reaction force of the sheet member 72. With this configuration of the present embodiment, outflowing of an airflow due to deflection, waviness, or the like of the sheet member 72 is reduced, and the sheet member 72 and the housing 54 reliably abut on each other at the gap t.

Therefore, the bending angle of the sheet member 72 is not limited to the angle according to the first embodiment or the present embodiment. As long as the sheet member 72 remains in contact with the housing 54 at the gap t because of the reaction force caused by the bending, some other bending angle may be adopted.

### Third Embodiment

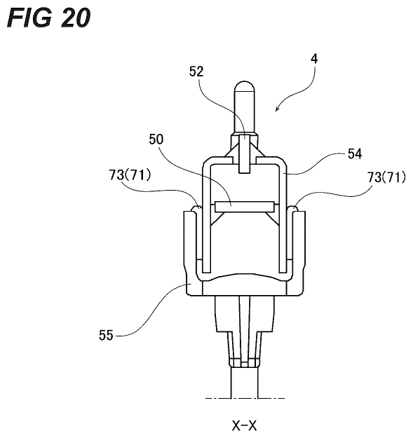

Referring now to FIG. 20, an exposure head 4 according to a third embodiment is described. FIG. 20 is a cross-sectional view of the exposure head 4 according to the third embodiment. Note that schematic configurations of the exposure head 4 and an image forming apparatus 100 are substantially the same as those of the first embodiment described above, and therefore, members having equivalent functions are denoted by the same reference numerals as those used in the first embodiment, and explanation thereof is not made herein.

In the foregoing embodiments, configurations in which the sealing member 71 is the sheet member 72 have been described as examples. However, embodiments are not limited to that, and the sealing member 71 may be a filler (sealant) 73.

As illustrated in FIG. 20, a moisture-curable silicone resin is applied as the filler 73 to a gap t between a housing support member 55 and a housing 54, and thus, the gap t is sealed. The filler 73 prevents an airflow from outflowing through the gap t of the exposure head 4, and reduces scattering of toner, minute dust, and the like.

Note that the filler (sealant) 73 is not necessarily a moisture-curable resin, and may be a photocurable adhesive, a foamed sealing material formed with a sponge material, or the like.

According to the present disclosure, it is possible to prevent an airflow from outflowing through a gap in an exposure device.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-085794, filed May 27, 2024, which is hereby incorporated by reference herein in its entirety.

What is claimed is:

1. An exposure device comprising:
a substrate on which a plurality of light emitting elements that emit light to expose a photosensitive member is arranged in an axial direction of the photosensitive member;
a lens array including a plurality of lenses that condense the light emitted from the light emitting elements onto the photosensitive member;
a housing that has an opening, and holds the substrate and the lens array;
a housing support member that is provided integrally on the housing to cover the opening of the housing, and forms a space that allows air to circulate between the housing and the exposure device; and
a sealing member that seals a gap between the housing and the housing support member facing each other on one side and another side of the substrate in a direction orthogonal to an optical axis direction along an optical axis of the lenses and the axial direction.

2. The exposure device according to claim 1, wherein
the opening of the housing is formed between substrate support portions that support the one side and the another side of the substrate in the direction orthogonal to the optical axis direction along the optical axis of the lenses and the axial direction,
the housing support member includes:
a first opposed portion that faces the substrate support portion on one side of the housing in the orthogonal direction; and
a second opposed portion that faces the substrate support portion on another side of the housing in the orthogonal direction, and faces the first opposed portion, with the housing being interposed between the first opposed portion and the second opposed portion, and
the sealing member seals a gap between the substrate support portion on the one side and the first opposed portion that face each other in the orthogonal direction, and a gap between the substrate support portion on the other side and the second opposed portion in the axial direction.

3. The exposure device according to claim 1, wherein
the housing support member has an opening communicating with an exposure cooling unit that generates an airflow that cools the exposure device, and
the opening of the housing support member is provided at a position facing a surface of the substrate held by the housing on an opposite side from a surface on which the light emitting elements are mounted.

4. The exposure device according to claim 3, wherein the sealing member is longer than a length from one end to another end of a region in which the opening of the housing support member is provided in the axial direction.

5. The exposure device according to claim 1, wherein the sealing member is a sheet member.

6. The exposure device according to claim 5, wherein one side of the sheet member in the orthogonal direction is bonded to and held by the housing support member, and another side of the sheet member is bent toward the gap between the housing and the housing support member, is inserted into the gap, and is brought into contact with the housing by a reaction force generated at time of the bending.

7. The exposure device according to claim 6, wherein
the housing support member includes a bonding portion that bonds the sheet member to a surface on an opposite side from a surface facing the housing in the orthogonal direction, and
the bonding portion has a shape recessed toward the housing in the orthogonal direction, unlike a portion adjacent to the bonding portion.

8. The exposure device according to claim 5, wherein the sheet member is a polyester film having a thickness not greater than 100 μm (micrometer).

9. The exposure device according to claim 1, wherein the sealing member is a filler.

10. The exposure device according to claim 1, wherein the light emitting elements are organic electro-luminescence (EL).

11. An image forming apparatus comprising: a photosensitive member; the exposure device according to claim 1; and an exposure cooling unit that generates an airflow that cools the exposure device.
